(19) United States
(12) Patent Application Publication
(10) Pub. No.: US 2014/0006666 A1
(43) Pub. Date: Jan. 2, 2014

(54) TASK SCHEDULING METHOD AND MULTI-CORE SYSTEM

(71) Applicant: FUJITSU LIMITED, Kawasaki (JP)

(72) Inventors: Tetsuo HIRAKI, Kawasaki (JP); Hiromasa YAMAUCHI, Kawasaki (JP); Koichiro YAMASHITA, Hachioji (JP); Fumihiko HAYAKAWA, Kawasaki (JP); Naoki ODATE, Akiruno (JP); Takahisa SUZUKI, Kawasaki (JP); Koji KURIHARA, Kawasaki (JP)

(73) Assignee: FUJITSU LIMITED, Kawasaki (JP)

(21) Appl. No.: 14/020,133

(22) Filed: Sep. 6, 2013

Related U.S. Application Data
(63) Continuation of application No. PCT/JP2011/055415, filed on Mar. 8, 2011.

(51) Int. Cl. G06F 9/48; G06F 13/24

(52) U.S. Cl. CPC G06F 9/4881; G06F 13/24
USPC 710/260; 718/102

(57) ABSTRACT

A task scheduling method is executed by a multi-core system and includes reading from a profile memory, first information concerning operation of a first task in a single core system; calculating second information concerning operation of a second task in the multi-core system, based on the first information; and setting based on the second information, an operating environment of a core that executes the second task.

### CROSS REFERENCE TO RELATED APPLICATIONS

This application is a continuation application of International Application PCT/JP2011/055415, filed on Mar. 8, 2011 and designating the U.S., the entire contents of which are incorporated herein by reference.

### FIELD

The embodiment discussed herein is related to a task scheduling method and a multi-core system.

### BACKGROUND

In recent years, many information apparatuses are expected to meet a growing demand for higher performance and lower power consumption; and system development using a multi-core processor has been implemented as a means for realizing higher performance and lower power consumption. Applying software assets developed for a single core to a multi-core system has also been put in practice.

Applying a multi-task program developed for a single core directly to a multi-core system may lead to a case where the execution sequence of tasks changes, causing the multi-task program to run in an unintended manner. To ensure that the multi-task program runs properly, a measure is taken such that synchronous code is embedded in program code.

According to a related technique, for example, the operating time of a thread in a task is determined. According to another technique, the operating frequency of a central processing unit (CPU) when the CPU operates a thread is set in advance. According to still another technique, a hardware thread profiler that is for multiple threads and collects profiling data of the threads is provided. For examples of such techniques, refer to Japanese Laid-Open Patent Publication Nos. H9-244891 and 2006-53830.

However, according to the conventional techniques, when a multi-task program developed for a single core is applied to a multi-core system, the time consumed for work of modifying the multi-task program increases, which eventually leads to a problem of a longer development period.

For example, analyzing a multi-core task program and embedding synchronous code in the program may consume many work hours. For example, verifying the quality of a program including embedded synchronous code therein may also consume many work hours. For example, a modification, such as embedding synchronous code in program code, may pose a problem that applying software assets to a different system becomes less easy.

### SUMMARY

According to an aspect of an embodiment, a task scheduling method is executed by a multi-core system and includes reading from a profile memory, first information concerning operation of a first task in a single core system; calculating second information concerning operation of a second task in the multi-core system, based on the first information; and setting based on the second information, an operating environment of a core that executes the second task.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of a sequence assuring process by a multi-core system according to an embodiment;

FIG. 2 is an explanatory diagram of an example of a system configuration of the multi-core system according to the embodiment;

FIG. 3 is a block diagram of an example of a hardware configuration of the sequence assuring apparatus according to the embodiment;

FIG. 4 is an explanatory diagram of an example of profile information;

FIG. 5 is a block diagram of a functional configuration of a sequence assuring apparatus according to the embodiment;

FIGS. 6 and 7 are flowcharts of an execution control procedure by a CPU according to a first example of the embodiment;

FIGS. 8 and 9 are flowcharts of a sequence assuring procedure by the sequence assuring apparatus according to the first example of the embodiment;

FIG. 10 is an explanatory diagram of an example of execution control by the multi-core system according to the first example;

FIG. 11 is a flowchart of an execution control procedure by a CPU according to a second example of the embodiment;

FIGS. 12, 13, and 14 are flowcharts of the sequence assuring procedure by the sequence assuring apparatus according to the second example of the embodiment; and

FIG. 15 is an explanatory diagram of an example of execution control by the multi-core system according to the second example.

### DESCRIPTION OF EMBODIMENTS

An embodiment of task scheduling method and multi-core system will be described in detail with reference to the accompanying drawings. As an example of a multi-core system that executes a task scheduling method according to the embodiment, a multi-core system including a multi-core processor equipped with multiple cores will be described. As long as multiple cores are provided, the multi-core processor may be a single processor equipped with multiple cores or a group of single-core processors in parallel. In the embodiment, for simpler explanation, a group of single-core processors in parallel will be described as an example.

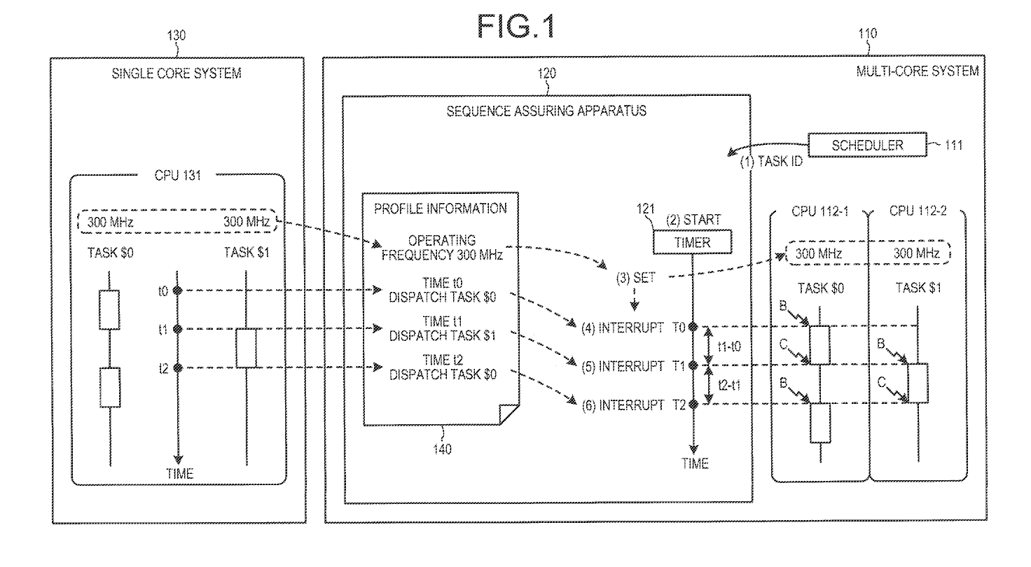

FIG. 1 is an explanatory diagram of an example of a sequence assuring process by a multi-core system according to the embodiment. In FIG. 1, a multi-core system 110 includes multiple CPUs (CPU 112-1 and CPU 112-2 in FIG. 1) and a sequence assuring apparatus 120.

The multi-core system 110 executes a multi-task program including a task $0 and a task $1. The task $0 and the task $1 make up a task group having dependency. A process is executed in units of tasks and a task includes one or more threads.

A task group having dependency is a task group in which a dependent relation exists between data handled by tasks. For example, a task that uses data generated by a different task and a task for which the generated data is used are included in such a task group having dependency.

In this example, the multi-task program including the tasks $0 and $1 is a program that has been developed for a single core and that runs properly when executed on a single core.

The sequence assuring apparatus 120 controls the execution sequence and processing times of tasks executed by a CPU. A scheduler 111 performs a process of scheduling the tasks executed by the CPU.

An example of a sequence assuring procedure by the multi-core system 110 will be described. A case is assumed where the task $0 is assigned to the CPU 112-1 and the task $1 is assigned to the CPU 112-2.

(1) The scheduler 111 transmits to the sequence assuring apparatus 120, a sequence assurance request concerning the multi-task program including the tasks $0 and $1. The sequence assurance request includes, for example, a task ID for identifying the task $0, which is subject to sequence assurance, and a task ID for identifying the task $1.

(2) When receiving the sequence assurance request from the scheduler 111, the sequence assuring apparatus 120 starts time counting by a timer 121.

(3) The sequence assuring apparatus 120 refers to profile information 140, and sets the operating frequency of each of the CPU 112-1 and CPU 112-2 of the multi-core system 110 to the operating frequency of a CPU 131 of a single core system 130. The profile information 140 includes information concerning the operation of a task in the single core system 130.

For example, the profile information 140 includes information that indicates the operating frequency of the CPU 131 that results when the tasks $0 and $1 operate properly in the single core system 130. In this example, the profile information 140 includes the operating frequency “300 MHz” of the CPU 131 that results when the tasks $0 and $1 operate properly in the single core system 130.

Thus, the sequence assuring apparatus 120 sets the operating frequency of each of the CPUs 112-1 and 112-2 of the multi-core system 110 to the operating frequency “300 MHz” of the CPU 131 of the single core system 130. As a result, the operating environment when the tasks $0 and $1 operate properly in the single core system 130 is reproduced in the multi-core system 110.

(4) The sequence assuring apparatus 120 refers to the profile information 140, and transmits an interrupt signal B requesting the start of the task $0 to the CPU 112-1. The profile information 140 includes information indicating the execution sequence of the tasks $0 and $1 and processing times (time slices) for the tasks $0 and $1 that result when the tasks $0 and $1 operate properly in the single core system 130.

For example, the profile information 140 includes information indicating that the task $0 has been dispatched by the CPU 131 of the single core system 130 at time “t0”. The profile information 140 also includes information indicating that the task $1 has been dispatched at time “t1”. The profile information 140 further includes information indicating that the task $0 has been dispatched at time “t2”.

Dispatching means delivering execution right to a task. When the task is dispatched, execution of the task is started. In other words, the sequence of tasks arranged in the temporal sequence of dispatching represents the execution sequence of the tasks. In this example, the tasks $0 and $1 are executed in the execution sequence of “task $0, task $1, and task $0”.

The task $0 is dispatched at time “t0”, at which execution of the task $0 is started. The task $0 continues to be executed until the task $1 is dispatched at time “t1”. A processing time for the task $0 is, therefore, calculated by, for example, subtracting time “t0” from time “t1”, which means that the processing time for the task $0 is “t1−t0”. A processing time for the task $1 is “t2−t1”.

For example, the sequence assuring apparatus 120 transmits to the CPU 112-1, the interrupt signal B requesting the start of the task $0 dispatched from the single core system 130 at time “t0”. In the following description, a point of time at which the interrupt signal B requesting the start of the task $0 has been transmitted to the CPU 112-1 in the multi-core system 110 is expressed as “time T0”.

(5) The sequence assuring apparatus 120 refers to the profile information 140, and transmits to the CPU 112-1, an interrupt signal C requesting the suspension of execution of the task $0. For example, the sequence assuring apparatus 120 refers to the time measured by the timer 121, and when the processing time “t1−t0” (hereinafter, this point of time is expressed as “time T1”) for the task $0 has elapsed since time T0, transmits the interrupt signal C requesting the suspension of execution of the task $0 to the CPU 112-1.

The sequence assuring apparatus 120 refers to the profile information 140, and transmits to the CPU 112-2, an interrupt signal B requesting the start of execution of the task $1. For example, when the processing time “t1-t0” for the task $0 has elapsed since time T0 (at time T1), the sequence assuring apparatus 120 transmits the interrupt signal B requesting the start of execution of the task $1 to the CPU 112-2.

In this manner, in the multi-core system 110, switching between the execution of the task $0 and the task $1 in the single core system 130 is reproduced.

(6) The sequence assuring apparatus 120 refers to the profile information 140, and transmits to the CPU 112-2, an interrupt signal C requesting the suspension of execution of the task $1. For example, when the processing time “t2-t1” for the task $1 has elapsed since time T1 (hereinafter, this point of time is expressed as “time T2”), the sequence assuring apparatus 120 transmits to the CPU 112-2, the interrupt signal C requesting the suspension of execution of the task $1.

The sequence assuring apparatus 120 refers to the profile information 140, and transmits to the CPU 112-1, an interrupt signal B requesting the start of execution of the task $0. For example, when the processing time “t2-t1” for the task $1 has elapsed since time T1 (at time T2), the sequence assuring apparatus 120 transmits to the CPU 112-1, the interrupt signal B requesting the start of execution of the task $0.

In this manner, in the multi-core system 110, switching between the execution of the task $0 and the task $1 in the single core system 130 is reproduced.

In this manner, the multi-core system 110 of the embodiment reproduces the execution sequence and processing times of the tasks $0 and $1 that operate properly in the single core system 130 and thereby, causes the tasks $0 and $1 to operate properly.

For example, the multi-core system 110 is able to set the operating frequency of the CPU 131 that runs the tasks $0 and $1 properly in the single core system 130, as the operating frequency of the CPU 112-1 and of the CPU 112-2. As a result, in the multi-core system 110, the operating environment of the single core system 130 in which the task $0 and the task $1 operate properly is reproduced.

The multi-core system 110 is able to control the start and suspension of execution of the tasks $0 and $1 executed by the CPUs 112-1 and 112-2, respectively, using the interrupt signals B and C. The multi-core system 110 can transmit the interrupt signals B and C to the CPUs 112-1 and 112-2, according to the execution sequence and processing times of the tasks $0 and $1 in the single core system 130. As a result, in the multi-core system 110, the execution sequence and processing times of the tasks $0 and $1 in the single core system 130 are reproduced.

In the above description, multiple tasks are taken as an example of the subject of the sequence assurance. This is not the only example. For example, multiple threads handling data dependent on each other may be the subject of the sequence assurance. In the following description, a task including multiple threads subjected to the sequence assurance (hereinafter, referred to as “subject task”) will be described as an example. A task not subjected to the sequence assurance is referred to as “non-subject task”.

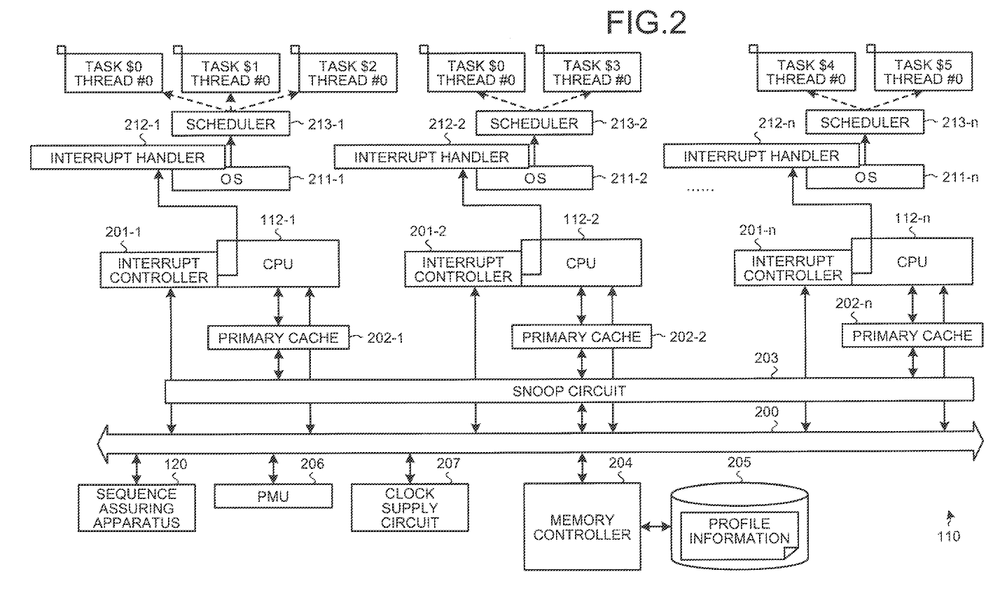

An example of a system configuration of the multi-core system 110 according to the embodiment will be described, referring to FIG. 2.

FIG. 2 is an explanatory diagram of an example of a system configuration of the multi-core system according to the embodiment. In FIG. 2, the multi-core system 110 includes CPUs 112-1 to 112-n, interrupt controllers 201-1 to 201-n, primary caches 202-1 to 202-n, a snoop circuit 203, a memory controller 204, memory 205, a power management unit (PMU) 206, a clock supply circuit 207, and the sequence assuring apparatus 120.

In the multi-core system 110, the CPUs 112-1 to 112-n, the primary caches 202-1 to 202-n, the snoop circuit 203, the memory controller 204, the PMU 206, the clock supply circuit 207, and the sequence assuring apparatus 120 are interconnected through a bus 200.

In FIG. 2, n is a natural number of 1 or more that represents the number of CPUs in the multi-core system 110. In the following description, an arbitrary CPU among the CPUs 112-1 to 112-n is expressed as “CPU 112-i (i=1, 2, . . . , n)”.

The CPU 112-i runs an operating system (OS) 211-i. For example, the CPU 112-1 runs an OS 211-1 and supervises overall control over the multi-core system 110. The OS 211-1 serves as a master OS, and has a scheduler 213-1 that performs control to determine to which CPU a task is to be assigned. The CPU 112-1 executes a task assigned thereto. The CPUs 112-2 to 112-n run OSs 211-2 to 211-n, respectively, and execute tasks assigned to the OSs. The OSs 211-2 to 211-n serve as slave OSs.

When an interrupt controller 201-i receives an interrupt signal from the sequence assuring apparatus 120, the interrupt controller 201-i causes the CPU 112-i to call an interrupt handler 212-i corresponding to the interrupt signal. The interrupt handler 212-i is a program that runs on the OS 211-i, and is executed when an interrupt signal is received. The interrupt handler 212-i is called when the CPU 112-i receives the interrupt signal from the sequence assuring apparatus 120, and communicates the reception of the interrupt signal to a scheduler 213-i.

The scheduler 213-i is a program that runs on the OS 211-i. Using the scheduler 213-i, the OS 211-i performs a process of scheduling tasks to be executed by the CPU 112-i. For example, each time a specified time slice expires, the OS 211-i switches a task to be executed by the CPU 112-i.

When the scheduler 213-i receives a request from the OS 211-i for starting execution of a task that is the subject of the sequence assurance, the scheduler 213-i changes the mode of the CPU 112-i to a mode in which the CPU 112-i receives an interrupt signal from the sequence assuring apparatus 120 (hereinafter, referred to as “interrupt permitting mode”).

A primary cache 202-i has a cache memory and a cache controller. The primary cache 202-i temporarily stores writing data to be written by a task executed by the OS 211-i to the memory 205. The primary cache 202-i temporarily stores data read out of the memory 205.

The snoop circuit 203 establishes the coherency of the primary caches 202-1 to 202-n to which the CPUs 112-1 to 112-n make access. For example, when data shared among the primary caches 202-1 to 202-n is updated at a primary cache 202-i among the primary caches 202-1 to 202-n, the snoop circuit 203 detects the data updating and updates the data contents of other primary caches.

The memory controller 204 controls the reading and writing of data with respect to the memory 205. The memory 205 is memory shared by the CPUs 112-1 to 112-n. The memory 205 includes, for example, read-only memory (ROM), random access memory (RAM), flash ROM, etc.

For example, the flash ROM stores OS programs; the ROM stores application programs; and the RAM is used as a work area of the CPU 112-i. The ROM also saves profile information. A program stored in the memory 205 is loaded onto a CPU 112-i, which executes a process coded in the program.

The PMU 206 supplies a source voltage to each component unit (CPU 112-i, bus 200, memory 205, etc.). The PMU 206 has a register in which each CPU 112-i can set the source voltage supplied to each component unit. The PMU 206 supplies the source voltage to each component unit, based on a value set in the register.

The clock supply circuit 207 supplies an operating frequency to each component unit. The clock supply circuit 207 has a register in which each CPU 112-i is able to set the operating frequency supplied to each component unit. The clock supply circuit 207 generates a clock based on a value set in the register and supplies the clock to each component unit.

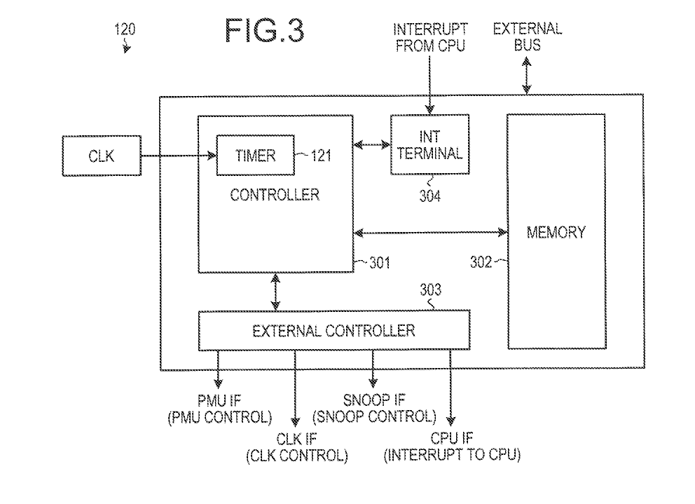

FIG. 3 is a block diagram of an example of a hardware configuration of the sequence assuring apparatus according to the embodiment. In FIG. 3, the sequence assuring apparatus 120 includes a controller 301, memory 302, an external controller 303, and an interrupt (INT) terminal 304, respectively interconnected via a bus.

The controller 301 supervises overall control of the sequence assuring apparatus 120. The controller 301 has a timer 121. The timer 121 counts pulse signals generated by clocks (CLK) to measure the elapsed time. The memory 302 stores a boot program. The memory 302, for example, stores the profile information 140 read out of the memory 205 of FIG. 2.

The external controller 303 transmits a control signal or an interrupt signal to each component unit, such as the interrupt controller 201-i, the snoop circuit 203, the PMU 206, and the clock supply circuit 207. For example, the external controller 303 transmits a control signal to the PMU 206 through a PMU interface (IF) and thereby, controls the source voltage supplied to each component unit. The external controller 303 transmits a control signal to the clock supply circuit 207 through a CLK IF and thereby, controls the operating frequency supplied to each component unit.

The external controller 303 transmits a control signal to the snoop circuit 203 through a snoop IF to cause the snoop circuit 203 to update the primary caches 202-1 to 202-n. The external controller 303 transmits an interrupt signal to the CPUs 112-1 to 112-n through a CPU IF. The INT terminal 304 receives an interrupt signal from any one of the CPUs 112-1 to 112-n.

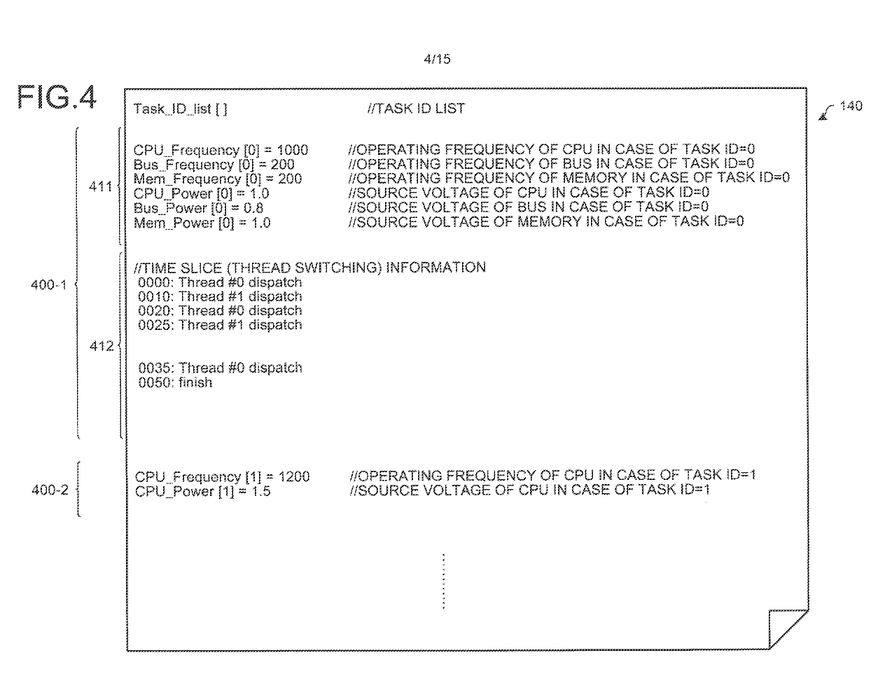

FIG. 4 is an explanatory diagram of a specific example of profile information. In FIG. 4, the profile information 140 has profile information of each task (e.g., profile information 400-1 and 400-2). An excerpted part of the profile information 140 is shown in FIG. 4.

The profile information 400-1 is profile information of the task $0 that is a subject task. For example, the profile information 400-1 includes operating environment information 411 and time slice information 412. The operating environment information 411 includes the operating frequency and the source voltage of the CPU 131 that result when the subject task $0 is executed in the single core system 130. The operating environment information 411 also includes the operating frequency and the source voltage of the bus that result when the subject task $0 is executed in the single core system 130. The operating environment information 411 further includes the operating frequency and the source voltage of the memory that result when the subject task $0 is executed in the single core system 130.

For example, “CPU_Frequency [0]” represents the operating frequency of the CPU 131 that results when the subject task $0 is executed in the single core system 130. “Bus_Frequency [0]” represents the operating frequency of the bus of the single core system 130 that results when the subject task $0 is executed in the single core system 130. “Mem_Frequency [0]” represents the operating frequency of the memory of the single core system 130 that results when the subject task $0 is executed in the single core system 130. “CPU_Power [0]” represents the source voltage of the CPU 131 that results when the subject task $0 is executed in the single core system 130. “BUS_Power [0]” represents the source voltage of the bus of the single core system 130 that results when the subject task $0 is executed in the single core system 130. “Mem_Power [0]” represents the source voltage of the memory of the single core system 130 that results when the subject task $0 is executed in the single core system 130.

The time slice information 421 includes information of thread switching in the subject task $0 executed in the single core system 130. For example, “0000: Thread #0 dispatch” indicates that the thread #0 in the subject task $0 is dispatched at time “0000”. “0050: finish” indicates that the subject task $0 is finished at time “0050”.

The profile information 400-2 is profile information of the task $1 that is a non-subject task. For example, the profile information 400-2 includes a preferable operating frequency and a preferable source voltage that is preferable for setting as the operating frequency and source voltage of the CPU 112-i to which the thread #0 of the non-subject task $1 is assigned.

For example, “CPU_Frequency [1]” represents an operating frequency that is preferable for setting as the operating frequency of the CPU 112-i to which the thread #0 of the non-subject task $1 is assigned. “CPU_Power [1]” represents a source voltage that is preferable for setting as the source voltage of the CPU 112-i to which the thread #0 of the non-subject task $1 is assigned.

An example of a functional configuration of the sequence assuring apparatus 120 will be described.

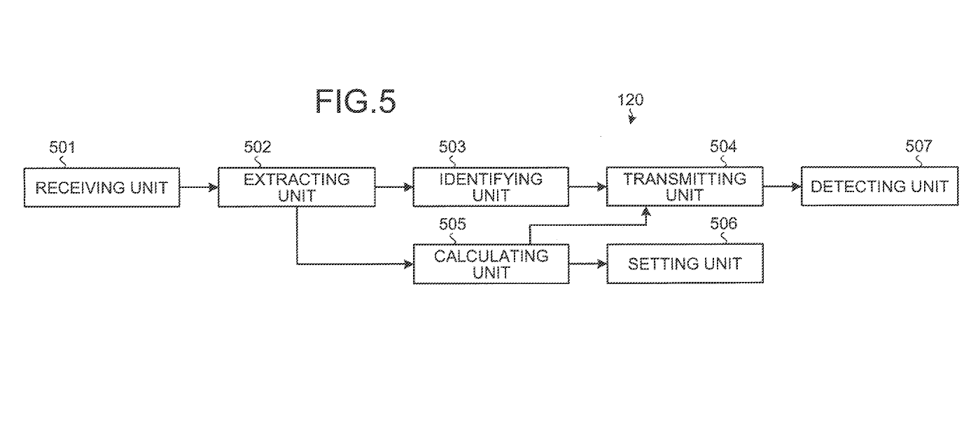

FIG. 5 is a block diagram of a functional configuration of the sequence assuring apparatus according to the embodiment. In FIG. 5, the sequence assuring apparatus 120 includes a receiving unit 501, an extracting unit 502, an identifying unit 503, a transmitting unit 504, a calculating unit 505, a setting unit 506, and a detecting unit 507. Functions of these functional units (receiving unit 501 to detecting unit 507) serving as a control unit are realized, for example, by causing the controller 301 to execute programs stored in the memory 302 depicted in FIG. 3 or through the external controller 303.

The receiving unit 501 has a function of receiving from the scheduler 213-i, a sequence assurance request concerning a subject task. The sequence assurance request concerning the subject task includes, for example, a task ID for the subject task and an identifier for each CPU 112-i to which each thread in the subject task is assigned.

For example, the receiving unit 501 receives a sequence assurance request including the task ID “0” for the subject task $0, the identifier for the CPU 112-1 to which the tread #0 in the subject task $0 is assigned, and the identifier for the CPU 112-2 to which the tread #1 in the subject task $0 is assigned. The received sequence assurance request concerning the subject task is stored, for example, in the memory 302.

The extracting unit 502 has a function of extracting from the memory 205 depicted in FIG. 2, profile information concerning the operation of the subject task in the single core system. For example, the extracting unit 502 extracts from the profile information 140 stored in the memory 205, the profile information 400-1 corresponding to the task ID “0” for the subject task $0 identified from the sequence assurance request. The extracted profile information is stored, for example, in the memory 302.

The identifying unit 503 has a function of referring to profile information extracted by the extracting unit 502 and identifying the execution sequence of threads in the subject task. For example, the identifying unit 503 refers to the time slice information 412 of the profile information 400-1 and identifies the sequence of dispatched threads arranged in temporal sequence, as the execution sequence of the threads. The identified execution sequence of the threads is stored, for example, in the memory 302.

The transmitting unit 504 has a function of transmitting the interrupt signal B requesting the start of execution of a thread in the subject task to the CPU 112-i to which the thread is assigned. For example, the transmitting unit 504 transmits the interrupt signal B requesting the start of execution of the thread #0 to be executed first among a group of threads in the subject task $0, to the CPU 112-1 to which the thread #0 is assigned, the CPU 112-1 being identified from a sequence assurance request concerning the subject task #0.

The calculating unit 505 has a function of referring to extracted profile information and calculating information concerning the operation of the subject task in the multi-core system 110. Information concerning the operation of the subject task is, for example, information that indicates a point of time at which execution of each thread in the subject task is started.

For example, the calculating unit 505 refers to the profile information and calculates a time between a point of time of the start of execution of a first thread and a point of time of the start of execution of a second thread to be executed next, as a processing time for the first thread.

A case of calculating a processing time for the thread #0 to be executed first will be described, referring to the time slice information 412 of the profile information 400-1. In this case, execution of the thread #0 is started at time “0000” and execution of the thread #1 is started at time “0010”. The processing time for the thread #0 is, therefore, given by subtracting “0000” from “0010”. Thus, the calculating unit 505 calculates the processing time for the thread #0 as “10”.

The detecting unit 507 has a function of detecting the elapse of the processing time for calculated by the calculating unit 505 for the first thread, from the point of time of the start of execution of the first thread. For example, the detecting unit 507 detects the elapse of the processing time for the first thread from the point of time of the start of execution of the first thread, based on the time measured by the timer 121.

For example, when an interrupt signal B requesting the start of execution of the thread #0 is transmitted, the detecting unit 507 saves the time measured by a timer 121. It is assumed, for example, the time measured by the timer 121 is “0030”. The detecting unit 507 detects time “0040” measured by the timer 121, time “0040” being obtained by adding the processing time “10” for the thread #0 to the saved time “0030”. Thus, the detecting unit 507 detects the elapse of the processing time for the thread #0.

The transmitting unit 504 has a function of transmitting to the CPU 112-i to which the first thread is assigned, an interrupt signal C requesting the suspension of execution of the first thread. For example, when the detecting unit 507 detects the elapse of the processing time for the first thread from a point of time of the start of execution of the first thread, the transmitting unit 504 transmits the interrupt signal C requesting the suspension of execution of the first thread to the CPU 112-i to which the first thread is assigned.

For example, when the elapse of the processing time “10” for the thread #0 of the subject task $0 from a point of time of the start of execution of the thread #0 is detected, the transmitting unit 504 transmits to the CPU 112-i to which the thread #0 is assigned, the interrupt signal C requesting the suspension of execution of the thread #0.

The transmitting unit 504 also has a function such that when the elapse of the processing time for the first thread under execution is detected, the transmitting unit 504 transmits to the CPU 112-i to which the thread of the non-subject task is assigned, an interrupt signal A requesting the suspension of execution of a thread of a non-subject task. For example, when the processing time “10” for the thread #0 of the subject task $0 has elapsed since a point of time of the start of execution of the thread #0, the transmitting unit 504 transmits to the CPU 112-2 to which the thread #0 is assigned, the interrupt signal A requesting the suspension of execution of the thread #0 of the non-subject task $0. In this manner, execution of the thread of the non-subject task can be suspended.

When the elapse of the processing time for the first thread under execution is detected, the transmitting unit 504 transmits an interrupt signal B requesting the start of execution of the second thread to the CPU 112-i to which the second thread to be executed following execution of the first thread is assigned, the second thread being identified by the identifying unit 503. For example, when the processing time “10” for the thread #0 of the subject task $0 has elapsed since a point of time of the start of execution of the thread #0, the transmitting unit 504 transmits the interrupt signal B requesting the start of execution of the thread #1 to the CPU 112-2 to which the thread #1 is assigned.

In this manner, the execution sequence and processing times of threads of the subject task (e.g., threads #0 and #1 of the subject task $0) in the single core system 130 are reproduced.

The transmitting unit 504 transmits to the CPU 112-i to which the thread is assigned, an interrupt signal D requesting the start of execution of a thread in a non-subject task. For example, the transmitting unit 504 transmits the interrupt signal D requesting the start of execution of the thread of the non-subject task to the CPU 112-i to which the interrupt signal C is transmitted when the processing time for the first thread under execution has elapsed.

For example, the transmitting unit 504 transmits the interrupt signal D requesting the start of execution of the thread #0 of the non-subject task $1 to the CPU 112-1 to which the interrupt signal C is transmitted when the processing time for the thread #0 of the subject task $0 has elapsed. In this manner, the thread executed at the CPU 112-i is changed from a thread of the subject task to a thread of a non-subject task.

The calculating unit 505 refers to extracted profile information and calculates a preset value set in the clock supply circuit 207 when the subject task is executed. The preset value of the clock supply circuit 207 is, for example, the ratio of the preferable operating frequency of the CPU 112-i, bus 200, memory 205, etc., to the resolution of the multi-core system 110 (e.g., “50”).

For example, the calculating unit 505 refers to the operating environment information 411 of the profile information 400-1 and identifies the operating frequency “1000” of the CPU 131 of the single core system 130. This operating frequency “1000” is a preferable operating frequency that should be preferably set as the operating frequency of the CPU 112-1 to which the thread #0 of the subject task $0 is assigned.

The calculating unit 505, for example, calculates the ratio “20” of the operating frequency “1000” of the CPU 131 of the single core system 130 to the resolution “50” of the multi-core system 110, as a preset value of the clock supply circuit 207 for the operating frequency of the CPU 112-1. The calculated ratio is stored, for example, to the memory 302.

For example, the calculating unit 505 refers to the operating environment information 411 of the profile information 400-1 and identifies the operating frequency “200” of the bus of the single core system 130. This operating frequency “200” is a preferable operating frequency that is preferable for setting as the operating frequency of the bus 200 of the multi-core system 110.

The calculating unit 505 then, for example, calculates the ratio “4” of the operating frequency “200” of the bus of the single core system 130 to the resolution “50” of the multi-core system 110, as a preset value of the clock supply circuit 207 for the operating frequency of the bus 200.

The bit width of the bus 200 of the multi-core system 110 may be different from the bit width of the bus of the single core system 130. In such a case, the calculating unit 505 calculates a preferable operating frequency that is preferable for setting as the operating frequency of the bus 200 of the multi-core system 110 while taking account of a bit width ratio of the systems.

For example, the calculating unit 505 calculates the ratio “2” of the bit width “64” of the bus of the single core system 130 to the bit width “32” of the bus 200 of the multi-core system 110. The calculating unit 505 then calculates a value “400” by multiplying the calculated bit width ratio “2” by the operating frequency “200” of the bus of the single core system 130, as the preferable operating frequency of the bus 200 of the multi-core system 110.

The calculating unit 505 then calculates a preset value related to the operating frequency of the bus 200, from the calculated preferable operating frequency “400” of the bus 200. The calculating unit 505 thus calculates the ratio “8” of the calculated operating frequency “400” to the resolution “50” of the multi-core system 110, as a preset value of the clock supply circuit 207 for the operating frequency of the bus 200.

A preset value related to the operating frequency of the memory 205 may be calculated in the same manner as the preset value related to the operating frequency of the bus 200 is calculated.

The setting unit 506 has a function of setting the operating environment of the multi-core system 110. For example, the setting unit 506 sets the operating frequency of the CPU 131 of the single core system 130 in the clock supply circuit 207, as the operating frequency of the CPU 112-i to which a thread of the subject task is assigned.

For example, the setting unit 506 transmits a control signal F for setting the calculated preset value “20” for the operating frequency of the CPU 112-1, to the clock supply circuit 207. As a result, the operating frequency of the CPU 112-1 to which the thread #0 of the subject task $0 is assigned may be set to an operating frequency equal to that of the CPU 131 of the single core system 130.

The setting unit 506 sets the source voltage of the CPU 131 of the single core system 130 in the PMU 206, as the source voltage of the CPU 112-i to which a thread of the subject task is assigned. For example, the setting unit 506 refers to the operating environment information 411 of the profile information 400-1 and identifies the source voltage “1.0” of the CPU 131 of the single core system 130. The setting unit 506 then transmits to the PMU 206, the control signal F for setting the identified source voltage “1.0” of the CPU 131 as the source voltage of the CPU 112-1 to which the thread #0 of the subject task $0 is assigned. As a result, the source voltage of the CPU 112-1 to which the thread #0 of the subject task $0 is assigned, is set to a source voltage equal to that of the CPU 131 of the single core system 130.

A preset value related to the source voltage of the bus 200 can be set in the same manner as the preset value related to the source voltage of the CPU 112-i is set. As a result, the source voltage of the bus 200 of the multi-core system 110 may be set to a source voltage equal to that of the bus of the single core system 130.

A preset value related to the source voltage of the memory 205 can be set in the same manner as the preset value related to the source voltage of the CPU 112-i is set. As a result, the source voltage of the memory 205 of the multi-core system 110 may be set to a source voltage equal to that of the memory of the single core system 130.

The receiving unit 501 has a function of receiving from the scheduler 213-i, scheduling information indicating a task ID for a non-subject task and an identifier for each CPU 112-i to which a thread in the non-subject task is assigned. This scheduling information is included, for example, in a sequence assurance request concerning the subject task.

For example, the receiving unit 501 receives from the scheduler 213-i, scheduling information indicating the task ID “1” for the non-subject task $1 and the identifier for the CPU 112-1 to which the thread #0 in the non-subject task $1 is assigned.

When a non-subject task is newly assigned to the CPU 112-i during execution of the subject task $0, the receiving unit 501 may receive from the scheduler 213-i, scheduling information concerning the newly assigned non-subject task.

The extracting unit 502 has a function of extracting from the memory 205 depicted in FIG. 2, profile information concerning the operation of a non-subject task in the multi-core system 110. For example, the extracting unit 502 extracts from the profile information 140 stored in the memory 205, the profile information 400-2 corresponding to the task ID “1” for the non-subject task $1 identified from a sequence assurance request.

The detecting unit 507 has a function of detecting the elapse of a given processing time from a point of time of the start of execution of a thread of a non-subject task. The given processing time is equivalent to a processing time (time slice) allocated to the thread of the non-subject task. A processing time for each thread of the non-subject task may be acquired from the scheduler 213-i by the sequence assuring apparatus 120 or may be calculated by the sequence assuring apparatus 120. For example, based on the time measured by the timer 121, the detecting unit 507 detects the elapse of a processing time for a third thread of the non-subject task from a point of time of the start of execution of the third thread.

For example, when an interrupt signal D requesting the start of execution of the thread #0 of the non-subject task $1 is transmitted, the detecting unit 507 saves the time measured by a timer 121. It is assumed, for example, the time measured by the timer 121 is “0040”. The detecting unit 507 detects time “0050” measured by the timer 121, time “0050” being given by adding the processing time “10” for the thread #0 of the non-subject task $1 to the saved time “0040”. Thus, the detecting unit 507 detects the elapse of the processing time for the thread #0 of the non-subject task $1.

The transmitting unit 504 has a function of transmitting to the CPU 112-i to which the thread of the non-subject task is assigned, an interrupt signal I requesting the suspension of execution of a thread of a non-subject task. The interrupt signal I is an interrupt signal that when the CPU 112-i changes the thread to be executed from a thread of the non-subject task to a thread of a different non-subject task, requests the suspension of execution of the thread of the non-subject task that is originally the thread to be executed. For example, when the elapse of the processing time for the third thread of the non-subject task from a point of time of the start of execution of the third thread is detected, the transmitting unit 504 transmits to the CPU 112-i to which the third thread is assigned, the interrupt signal I requesting the suspension of execution of the third thread.

For example, when the elapse of the processing time “10” for the thread #0 of the subject task $1 from a point of time of the start of execution of the thread #0 is detected, the transmitting unit 504 transmits to the CPU 112-i to which the thread #0 is assigned, the interrupt signal I requesting the suspension of execution of the thread #0.

The transmitting unit 504 transmits an interrupt signal j requesting the start of execution of a fourth thread of the non-subject task to the CPU 112-i to which the interrupt signal I is transmitted when the processing time for the third thread of the non-subject task under execution has elapsed. The interrupt signal j is an interrupt signal that when the CPU 112-i changes the thread to be executed from a thread of a non-subject task to a thread of a different non-subject task, requests the start of execution of the thread of the different non-subject task newly designated as the thread to be executed. For example, the transmitting unit 504 transmits the interrupt signal j requesting the start of execution of the thread #0 of a non-subject task $2 to the CPU 112-1 to which the interrupt signal I is transmitted when the processing time for the thread #0 of the non-subject task $1 has elapsed.

The calculating unit 505 may refer to profile information of an extracted non-subject task and calculate a preset value set in the clock supply circuit 207 when the non-subject task is executed. For example, the calculating unit 505 refers to the profile information 400-2 of the non-subject task $1 and identifies a preferable operating frequency “1200” that is preferable for setting as the operating frequency of the CPU 112-1 to which the thread #0 of the non-subject task $1 is assigned.

The calculating unit 505, for example, calculates the ratio “24” of the preferable operating frequency “1200” to the resolution “50” of the multi-core system 110, as a preset value of the clock supply circuit 207 for the operating frequency of the CPU 112-1.

The setting unit 506 sets a preferable operating frequency in the clock supply circuit 207, as the operating frequency of the CPU 112-i to which a thread of a non-subject task is assigned. For example, the setting unit 506 transmits to the clock supply circuit 207, a control signal F for setting the calculated preset value “24” for the operating frequency of the CPU 112-1. Through this process, the operating frequency of the CPU 112-1 to which the thread #0 of the non-subject task $1 is assigned can be set to the preferable operating frequency (e.g., overclocking).

The setting unit 506 sets the preferable source voltage of the CPU 131 in the PMU 206, as the source voltage of the CPU 112-i to which a thread of a non-subject task is assigned. For example, the setting unit 506 refers to the profile information 400-2 and identifies the source voltage “1.5” of the CPU 131 of the single core system 130. The setting unit 506 then transmits to the PMU 206, a control signal F for setting the identified source voltage “1.5” of the CPU 131 as the source voltage of the CPU 112-1 to which the thread #0 of the non-subject task $1 is assigned. As a result, the source voltage of the CPU 112-1 to which the thread #0 of the non-subject task $1 is assigned is set to the preferable source voltage.

If execution of the subject task has ended, the transmitting unit 504 transmits an interrupt signal E requesting the termination of the subject task, to all of the CPUs 112-1 to 112-n. For example, when the processing time “10” for the thread #0 of the subject task #0 of which the sequence of execution is identified as the last has elapsed since a point of time of the start of execution of the thread #0, the transmitting unit 504 transmits to each CPU 112-i, the interrupt signal E requesting the termination of execution of the subject task. As a result, the scheduler 213-i terminates the execution of the subject task and returns the CPU 112-i in the interrupt permitting mode to the ordinary mode.

The transmitting unit 504 transmits a control signal G for returning the operating environment set by the setting unit 506 to an ordinary operating environment. For example, when execution of a thread of the subject task is suspended and execution of a thread of a non-subject task is started, the transmitting unit 504 transmits to the clock supply circuit 207 and the PMU 206, the control signal G for returning the operating environment of the multi-core system 110 to the ordinary operating environment. For example, when execution of the subject task is terminated, the transmitting unit 504 transmits to the clock supply circuit 207 and the PMU 206, the control signal G for returning the operating environment of the multi-core system 110 to the ordinary operating environment. In this manner, the operating environment of the multi-core system 110 set to the operating environment of the single core system 130 can be returned to the ordinary operating environment.

The transmitting unit 504 transmits to the snoop circuit 203, a control signal H that causes the snoop circuit 203 to perform a snoop process for maintaining coherency. For example, when execution of a thread of the subject task is suspended and execution of a thread of a non-subject task is also suspended, the transmitting unit 504 transmits to the snoop circuit 203, the control signal H that causes the snoop circuit 203 to maintain coherency. Through this process, the consistency of the primary caches 201-1 to 202-n may be established.

In the above description, the transmitting unit 504 transmits various interrupt signals to the specific CPU 112-i only. This is, however, not the only case. For example, the transmitting unit 504 may transmit an interrupt signal to all of the CPUs 112-1 to 112-n. In this case, the CPU 112-i receiving the incoming interrupt signal determines whether the interrupt signal is a signal addressed to the CPU 112-i, and discards the interrupt signal or performs a process according to the interrupt signal.

A case where the transmitting unit 504 transmits an interrupt signal C requesting the suspension of the thread #0 of the subject task $0 to all of the CPUs 112-1 to 112-n will be described as an example. Each CPU 112-i determines whether a thread under execution by the CPU 112-i is the thread #0 of the subject task $0. If the thread under execution by the CPU 112-i is the thread #0 of the subject task $0, each CPU 112-i determines that the interrupt signal C is a signal addressed to the CPU 112-i and therefore, suspends execution of the thread #0 of the subject task $0. If the thread under execution by the CPU 112-i is not the thread #0 of the subject task $0, each CPU 112-i determines that the interrupt signal C is not a signal addressed to the CPU 112-i and therefore, discards the interrupt signal.

A first example of the embodiment will be described. The first example relates to a case where sequence assurance on the subject task is performed in the multi-core system 110. An execution control procedure by the CPU 112-i of the multi-core system 110 according to the first example will first be described.

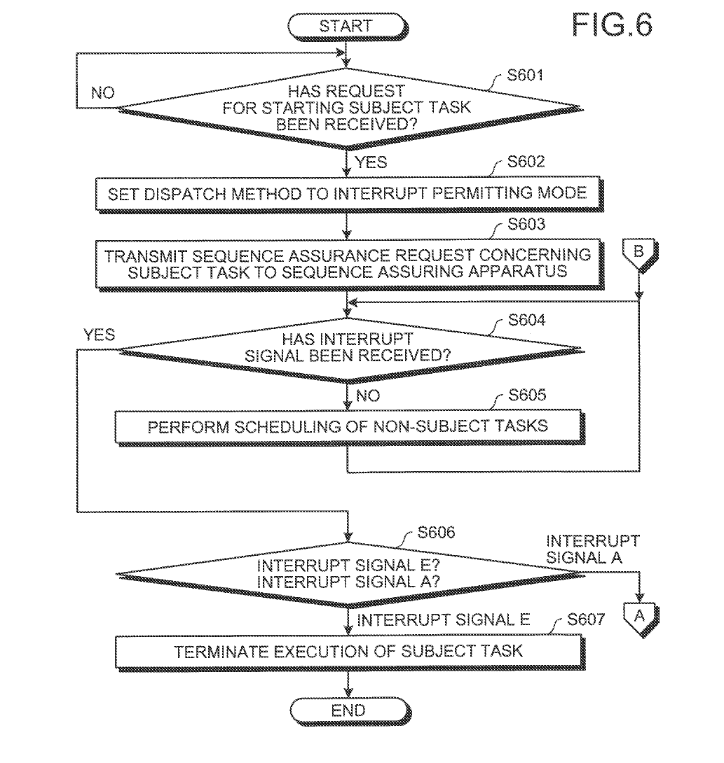

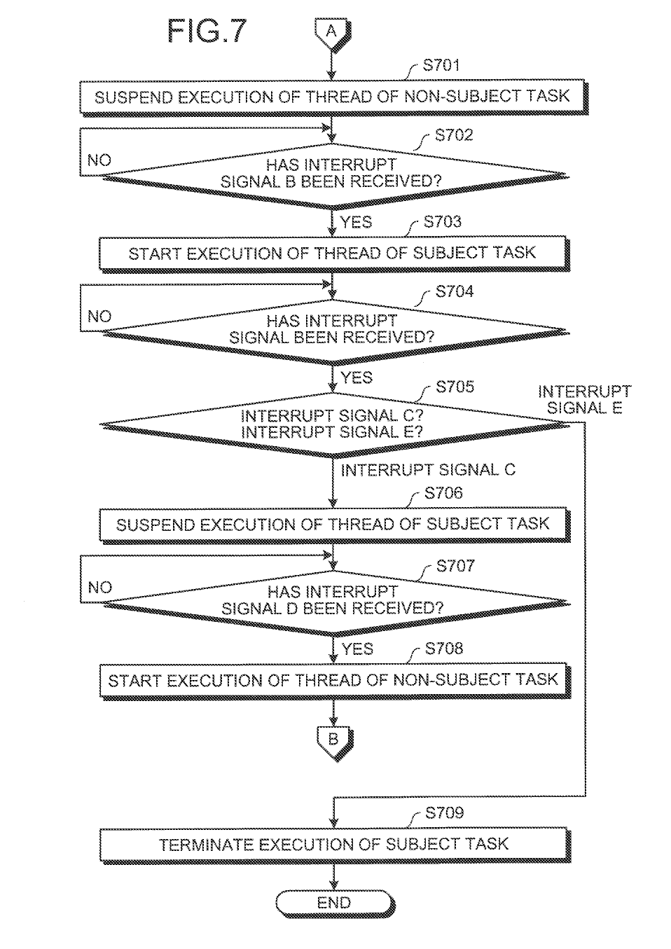

FIGS. 6 and 7 are flowcharts of an execution control procedure by a CPU according to the first example of the embodiment. In the flowchart of FIG. 6, the CPU 112-i first determines whether a request for starting a subject task has been received (step S601).

The CPU 112-i waits for a request for starting a subject task (step S601: NO), and upon receiving a request for starting a subject task (step S601: YES), sets the dispatch method to the interrupt permitting mode (step S602).

The CPU 112-i then transmits a sequence assurance request concerning the subject task to the sequence assuring apparatus 120 (step S603). Subsequently, the CPU 112-i determines whether an interrupt signal transmitted from the sequence assuring apparatus 120 has been received (step S604).

If no interrupt signal has been received (step S604: NO), the CPU 112-i performs scheduling of non-subject tasks (step S605), and returns to step S604.

If an interrupt signal has been received (step S604: YES), the CPU 112-i determines whether the received interrupt signal is an interrupt signal E requesting the termination of execution of the subject task or an interrupt signal A requesting the suspension of execution of a thread of a non-subject task (step S606).

If the received interrupt signal is the interrupt signal E (step S606: interrupt signal E), the CPU 112-i terminates the execution of the subject task (step S607), and ends a series of steps of the flowchart. At this time, the CPU 112-i changes the dispatch method from the interrupt permitting mode back to the ordinary mode.

If the received interrupt signal is the interrupt signal A at step S606 (step S606: interrupt signal A), the CPU 112-i proceeds to step S701 of FIG. 7.

In the flowchart of FIG. 7, the CPU 112-i first suspends execution of a thread of a non-subject task (step S701). The CPU 112-i then determines whether an interrupt signal B requesting the start of execution of a thread of the subject task has been received, the interrupt signal B being transmitted from the sequence assuring apparatus 120 (step S702).

The CPU 112-i waits for reception of an interrupt signal B (step S702: NO), and upon receiving an interrupt signal B (step S702: YES), starts executing the thread of the subject task (step S703). The CPU 112-i then determines whether an interrupt signal transmitted from the sequence assuring apparatus 120 has been received (step S704).

The CPU 112-i waits for reception of the interrupt signal (step S704: NO), and upon receiving the interrupt signal (step S704: YES), the CPU 112-i determines whether the received interrupt signal is an interrupt signal C requesting the suspension of execution of the thread of the subject task or the interrupt signal E requesting the termination of execution of the subject task (step S705).

If the received interrupt signal is the interrupt signal C (step S705: interrupt signal C), the CPU 112-i suspends execution of the thread of the subject task (step S706). The CPU 112-i then determines whether an interrupt signal D requesting the start of the thread of the non-subject task has been received, the interrupt signal D being transmitted from the sequence assuring apparatus 120 (step S707).

The CPU 112-i waits for reception of the interrupt signal D (step S707: NO). Upon receiving the interrupt signal D (step S707: YES), the CPU 112-i starts executing the thread of the non-subject task (step S708) and returns to step S604 of FIG. 6.

At step S705, if the received interrupt signal is the interrupt signal E (step S705: interrupt signal E), the CPU 112-i terminates the execution of the subject task (step S709), and ends a series of steps of the flowchart. At this time, the CPU 112-i changes the dispatch method from the interrupt permitting mode back to the ordinary mode.

In this manner, when a request for starting the subject task is issued, the thread to be executed may be switched based on an interrupt signal from the sequence assuring apparatus 120.

An sequence assuring procedure by the sequence assuring apparatus 120 of the multi-core system 110 according to the first example will be described.

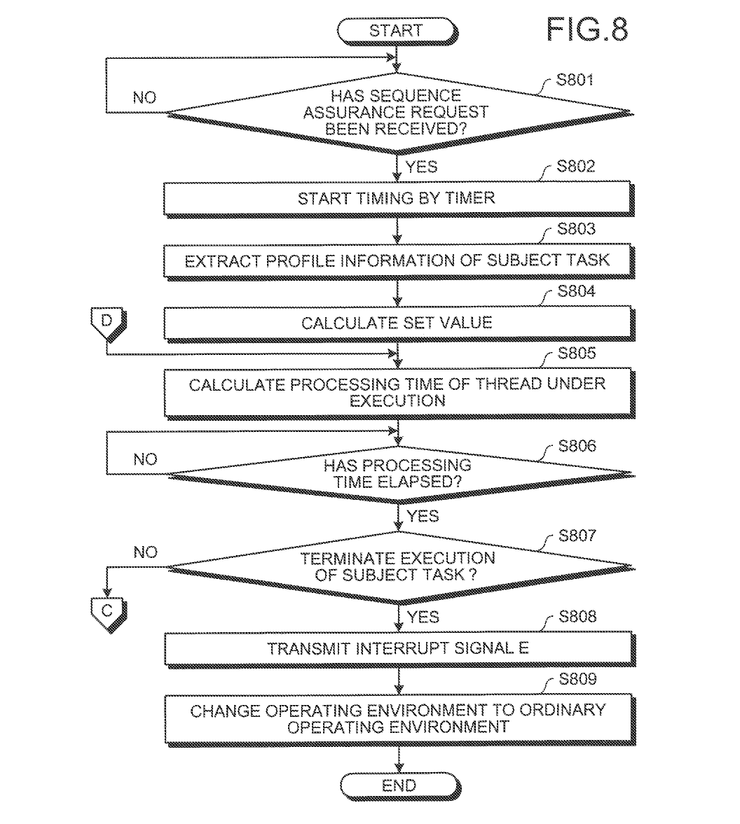

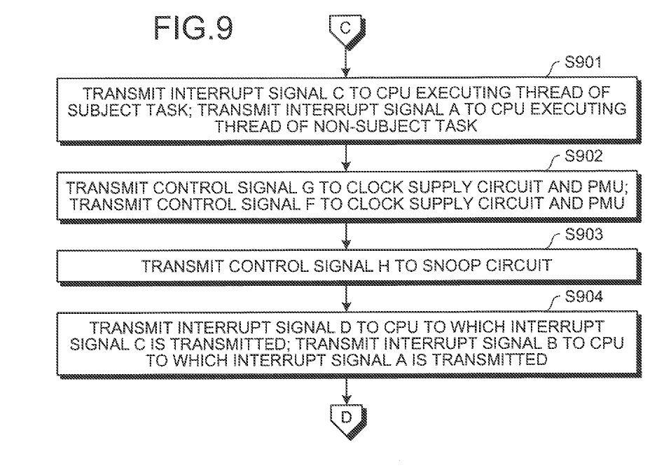

FIGS. 8 and 9 are flowcharts of the sequence assuring procedure by the sequence assuring apparatus according to the first example of the embodiment. In the flowchart of FIG. 8, the sequence assuring apparatus 120 determines whether a sequence assurance request concerning the subject task from the scheduler 213-i has been received (step S801).

The sequence assuring apparatus 120 waits for reception of a sequence assurance request concerning a subject task (step S801: NO), and upon receiving a sequence assurance request concerning a subject task (step S801: YES), causes the timer 121 to start time counting (step S802). The sequence assuring apparatus 120 then extracts profile information of the subject task from the memory 205 (step S803).

The sequence assuring apparatus 120 refers to the extracted profile information, and calculates a preset value set in the clock supply circuit 207 when the subject task is executed (step S804). The preset value set in the clock supply circuit 207 is, for example, the ratio of the preferable operating frequency of the CPU 112-i, bus 200, memory 205, etc., to the resolution of the multi-core system 110.

Subsequently, the sequence assuring apparatus 120 refers to the extracted profile information and calculates the time between a point of time of the start of execution of a thread under execution and a point of time of the start of execution of a thread to be executed next, as a processing time for the thread under execution (step S805).

The sequence assuring apparatus 120 then determines whether the processing time for the thread under execution has elapsed (step S806). The sequence assuring apparatus 120 waits for the elapse of the processing time for the thread under execution (step S806: NO), and when the processing time has elapsed (step S806: YES), refers to the profile information to determine whether to terminate execution of the subject task (step S807).

If execution is not to be terminated (step S807: NO), the sequence assuring apparatus 120 proceeds to step S901 of FIG. 9.

If the execution of the subject task is to be terminated (step S807: YES), the sequence assuring apparatus 120 transmits to each CPU 112-i, an interrupt signal E requesting the termination of execution of the subject task (step S808). The sequence assuring apparatus 120 then changes the operating environment of the multi-core system 110 back to the ordinary operating environment (step S809), and ends a series of steps of the flowchart.

In the flowchart of FIG. 9, the sequence assuring apparatus 120 transmits an interrupt signal C requesting the suspension of execution of a thread of the subject task to the CPU 112-i executing the thread of the subject task (step S901). At step S901, the sequence assuring apparatus 120 also transmits an interrupt signal A requesting the suspension of execution of a thread of a non-subject task to a CPU 112-j (i≠j, j=1, 2, . . . , n) executing the thread of the non-subject task (step S901).

The sequence assuring apparatus 120 then transmits to the clock supply circuit 207 and the PMU 206, a control signal G for changing the operating environment (operating frequency, source voltage) of the CPU 112-i, to which the interrupt signal C is transmitted, back to the ordinary operating environment (step S902). At step S902, the sequence assuring apparatus 120 also transmits to the clock supply circuit 207 and the PMU 206, a control signal F for changing the operating environment of the CPU 112-j, to which the interrupt signal A is transmitted, to the operating environment of the single core system 130 (step S902). The operating environment of the single core system 130 includes an operating frequency that is based on the preset value calculated at step S804 and a source voltage identified from the profile information.

Subsequently, the sequence assuring apparatus 120 transmits to the snoop circuit 203, a control signal H causing the snoop circuit 203 to execute the snoop process for maintaining coherency (step S903).

The sequence assuring apparatus 120 then transmits an interrupt signal D requesting the start of execution of the thread of the non-subject task to the CPU 112-i to which the interrupt signal C is transmitted (step S904). At step S904, the sequence assuring apparatus 120 also transmits an interrupt signal B requesting the start of execution of the thread of the subject task to the CPU 112-j to which the interrupt signal A is transmitted (step S904), and returns to step S805.

Through this procedure, in the multi-core system 110, when the subject task is executed, the same operating environment as that of the single core system 130 can be reproduced and the execution sequence and processing times of threads of the subject task can also be reproduced.

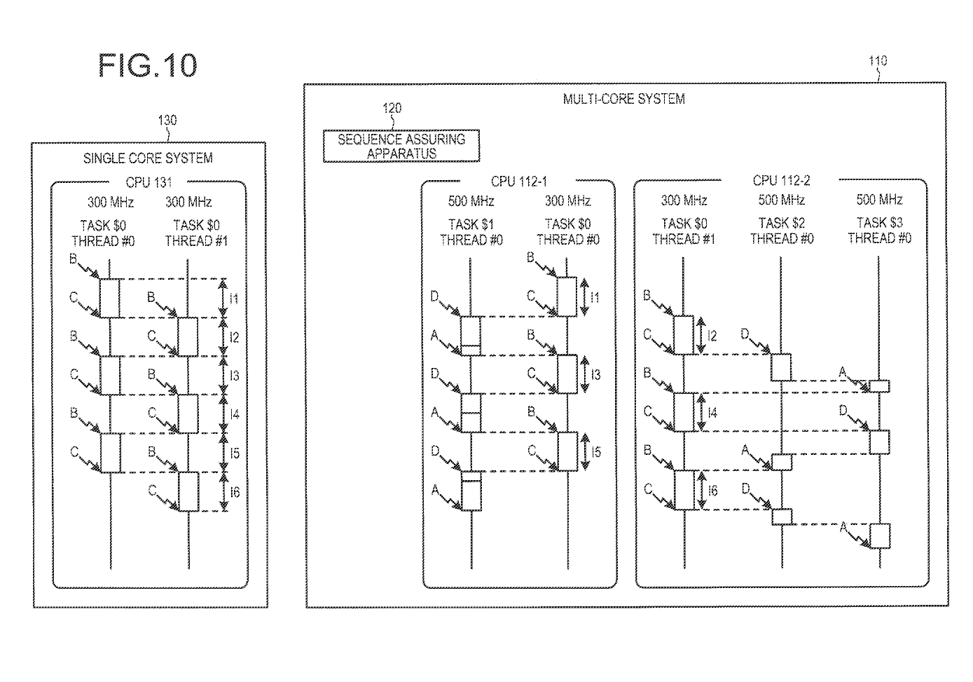

An example of execution control by the multi-core system 110 according to the first example will be described, referring to FIG. 10.

FIG. 10 is an explanatory diagram of an example of execution control by the multi-core system 110 according to the first example. In FIG. 10, the multi-core system 110 includes the CPUs 112-1 and 112-2. To the CPU 112-1, the thread #0 of the subject task $0 and the thread #0 of the non-subject task $1 are assigned. To the CPU 112-2, the thread #1 of the subject task $0, the thread #0 of the non-subject task $2, and the thread #0 of a non-subject task $3 are assigned.

When the CPU 112-1 receives a request for starting the subject task $0, the CPU 112-1 transmits a sequence assurance request concerning the subject task $0 to the sequence assuring apparatus 120 and changes the dispatch method to the interrupt permitting mode.

Receiving the sequence assurance request concerning the subject task $0, the sequence assuring apparatus 120 sets the operating frequency of the CPU 112-1 to an operating frequency equal to that of the CPU 131 of the single core system 130 when the CPU 112-1 starts executing the thread #0 of the subject task $0. The sequence assuring apparatus 120 also sets the operating frequency of the CPU 112-2 to an operating frequency equal to that of the CPU 131 of the single core system 130 when the CPU 112-2 starts executing the thread #1 of the subject task $0. As a result, the operating environment of each of the CPUs 112-1 and 112-2 that are executing the subject task $0 becomes identical to the operating environment of the CPU 131 of the single core system 130.

The sequence assuring apparatus 120 calculates the execution sequence of the threads #0 and #1 of the subject task $0 and processing times for the threads #0 and #1, based on profile information of the subject task $0. Based on the time measured by the timer 121, the sequence assuring apparatus 120 transmits the interrupt signal B and interrupt signal C to the CPUs 112-1 and 112-2 according to the execution sequence and processing times of the threads #0 and #1. As a result, each of the threads #0 and #1 of the subject task $0 is executed for the same processing time as allocated in the single core system 130 (which is indicated by I1 to I6 in FIG. 10) and in the same execution sequence as set in the single core system 130.

In this manner, in the multi-core system 110, when the subject task $0 is executed, the same operating environment as that of the single core system 130 is reproduced and the execution sequence and processing times of the threads #0 and #1 of the subject task $0 are also reproduced. The multi-core system 110, therefore, causes the subject task $0 to perform the same normal operation as the subject task $0 performs in the single core system 130.

The sequence assuring apparatus 120 transmits the interrupt signals D and interrupt signal A to the CPUs 112-1 and 112-2 at which execution of the threads #0 and #1 of the subjects task $0 is suspended. This causes the CPUs 112-1 and 112-2 to start executing the non-subject tasks $1, $2, and $3.

A second example of the embodiment will be described. The second embodiment relates to a case where sequence assurance on all tasks (subject task, non-subject task) is performed in the multi-core system 110. An execution control procedure by the CPU 112-i of the multi-core system 110 according to the second embodiment will first be described.

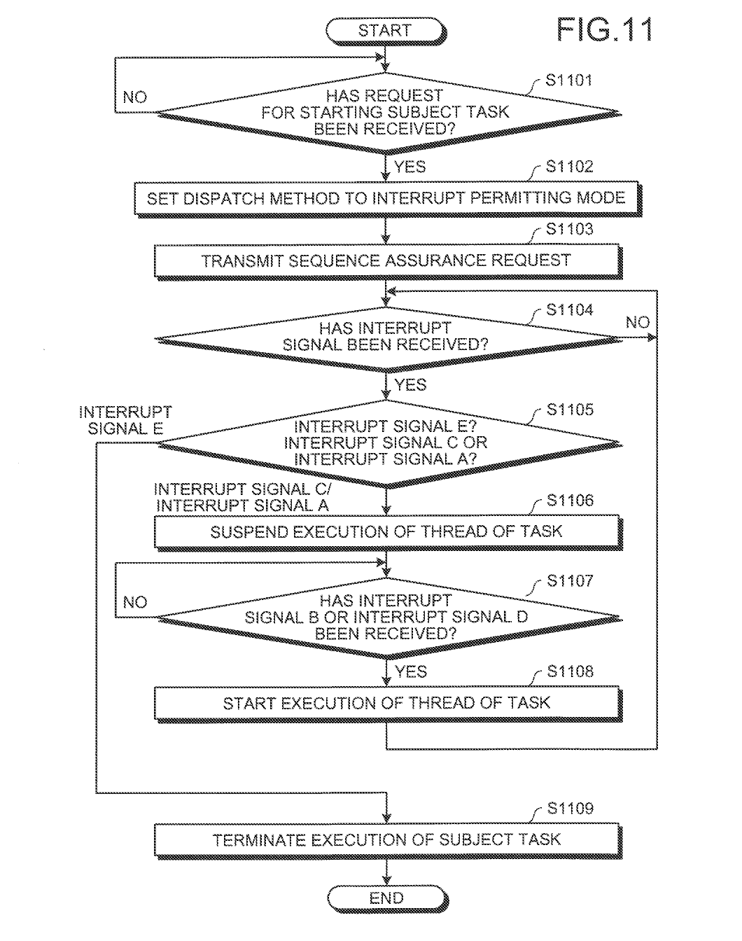

FIG. 11 is a flowchart of an execution control procedure by a CPU according to the second example of the embodiment. In the flowchart of FIG. 11, the CPU 112-i first determines whether a request for starting a subject task has been received (step S1101).

The CPU 112-i waits for a request for starting a subject task (step S1101: NO), and upon receiving a request for starting a subject task (step S1101: YES), sets the dispatch method to the interrupt permitting mode (step S1102).

The CPU 112-i then transmits to the sequence assuring apparatus 120, a sequence assurance request concerning the subject task (step S1103). This sequence assurance request includes task IDs for all tasks that are scheduled at a point of time of reception of the request for starting the subject task $0 and the identifier for the CPU 112-i to which the tasks are assigned.

Subsequently, the CPU 112-i determines whether an interrupt signal transmitted from the sequence assuring apparatus 120 has been received (step S1104). The CPU 112-i waits for reception of an interrupt signal (step S1104: NO).

Upon receiving an interrupt signal (step S1104: YES), the CPU 112-i determines whether the received interrupt signal is an interrupt signal E requesting the termination of execution of the subject task or an interrupt signal C or interrupt signal A requesting the suspension of execution of a thread of a task under execution (step S1105). The interrupt signal C is an interrupt signal that requests the suspension of execution of the subject task. The interrupt signal A is an interrupt signal that requests the suspension of execution of a non-subject task.

If the received interrupt signal is the interrupt signal C or interrupt signal A (step S1105: interrupt signal C/interrupt signal A), the CPU 112-i suspends execution of a thread of a task of which the suspension is requested by the received interrupt signal C or interrupt signal A (step S1106).

The CPU 112-i then determines whether an interrupt signal B or interrupt signal D requesting the start of execution of a thread of a task has been received from the sequence assuring apparatus 120 (step S1107). The interrupt signal B is an interrupt signal that requests the start of execution of the subject task. The interrupt signal D is an interrupt signal that requests the start of execution of a non-subject task.

The CPU 112-i waits for reception of an interrupt signal B or interrupt signal D (step S1107: NO). Upon receiving the interrupt signal B or interrupt signal D (step S1107: YES), the CPU 112-i starts executing a thread of a task of which the start is requested by the received interrupt signal B or interrupt signal D (step S1108), and returns to step S1104.

At step S1105, when the received interrupt signal is the interrupt signal E (step 1105: interrupt signal E), the CPU 112-i terminates execution of the subject task (step S1109), and ends a series of steps of the flowchart. At this time, the CPU 112-i changes the dispatch method from the interrupt permitting mode back to the ordinary mode.

In this manner, when a request for starting the subject task is issued, a thread to be executed may be switched between a thread of the subject task and a thread of a non-subject task, according to an interrupt signal from the sequence assuring apparatus 120.

An sequence assuring procedure by the sequence assuring apparatus 120 of the multi-core system 110 according to the second example will be described.

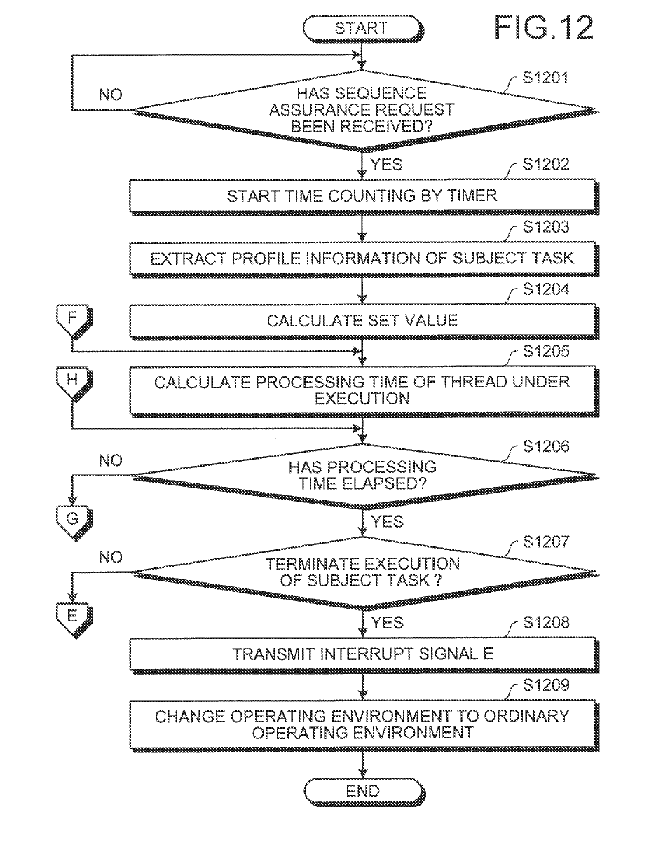

FIGS. 12, 13, and 14 are flowcharts of the sequence assuring procedure by the sequence assuring apparatus according to the second example of the embodiment. In the flowchart of FIG. 12, the sequence assuring apparatus 120 determines whether a sequence assurance request concerning a subject task has been received from the scheduler 213-i (step S1201).

The sequence assuring apparatus 120 waits for reception of a sequence assurance request concerning a subject task (step S1201: NO), and upon receiving a sequence assurance request concerning a subject task (step S1201: YES), starts time counting by the timer 121 (step S1202). The sequence assuring apparatus 120 then extracts from the memory 205, profile information of the subject task (step S1203).

The sequence assuring apparatus 120 then refers to the extracted profile information, and calculates a preset value set in the clock supply circuit 207 when the subject task is executed (step S1204). The preset value set in the clock supply circuit 207 is, for example, the ratio of the preferable operating frequency of the CPU 112-i, bus 200, memory 205, etc. to the resolution of the multi-core system 110.

Subsequently, the sequence assuring apparatus 120 refers to the extracted profile information and calculates the time between a point of time of the start of execution of a thread under execution and a point of time of the start of execution of a thread to be executed next, as a processing time for the thread under execution (step S1205).

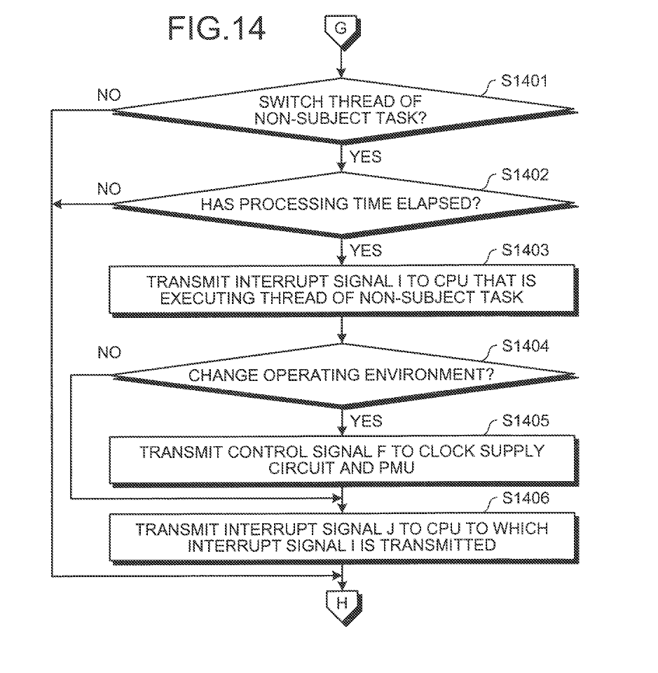

The sequence assuring apparatus 120 then determines whether the processing time for the thread under execution has elapsed (step S1206). If the processing time for the thread under execution has not elapsed (step S1206: NO), the sequence assuring apparatus 120 proceeds to step S1401 of FIG. 14.

If the processing time for the thread under execution has elapsed (step S1206: YES), the sequence assuring apparatus 120 refers to the profile information and determines whether to terminate execution of the subject task (step S1207).

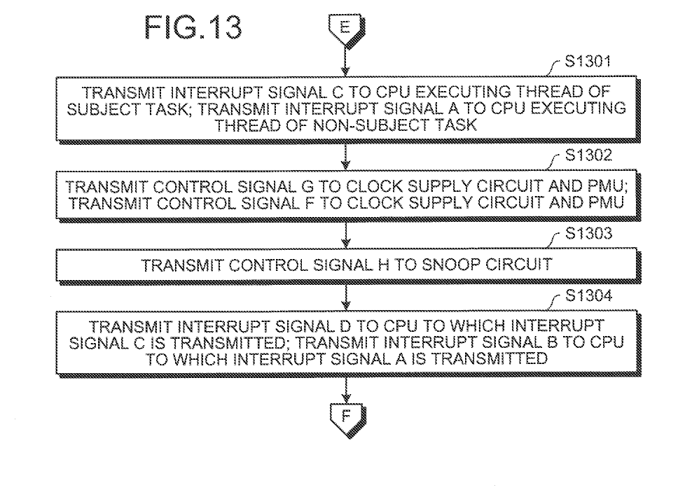

If the execution of the subject task is not to be terminated (step S1207: NO), the sequence assuring apparatus 120 proceeds to step S1301 of FIG. 13. If the execution of the subject task is to be terminated (step S1207: YES), the sequence assuring apparatus 120 transmits an interrupt signal E requesting the termination of execution of the subject task to each CPU 112-i (step S1208).

The sequence assuring apparatus 120 then changes the operating environment of the multi-core system 110 to the ordinary operating environment (step S1209), and ends a series of steps of the flowchart.

In the flowchart of FIG. 13, the sequence assuring apparatus 120 transmits an interrupt signal C requesting the suspension of execution of a thread of the subject task to the CPU 112-i executing the thread of the subject task (step S1301). At step S1301, the sequence assuring apparatus 120 also transmits an interrupt signal A requesting the suspension of execution of a thread of a non-subject task to a CPU 112-j executing the thread of the non-subject task (step S1301).

The sequence assuring apparatus 120 then transmits to the clock supply circuit 207 and the PMU 206, a control signal G for changing the operating environment (operating frequency, source voltage) of the CPU 112-i to which the interrupt signal C is transmitted, to the ordinary operating environment (step S1302). At step S1302, the sequence assuring apparatus 120 also transmits to the clock supply circuit 207 and the PMU 206, a control signal F for changing the operating environment of the CPU 112-j to which the interrupt signal A is transmitted, to the operating environment of the single-core system 130 (step S1302).

Subsequently, the sequence assuring apparatus 120 transmits to the snoop circuit 203, a control signal H causing the snoop circuit 203 to execute the snoop process for maintaining coherency (step S1303).

The sequence assuring apparatus 120 then transmits an interrupt signal D requesting the start of execution of the thread of the non-subject task to the CPU 112-i to which the interrupt signal C is transmitted (step S1304). At step S1304, the sequence assuring apparatus 120 also transmits an interrupt signal B requesting the start of execution of the thread of the subject task to the CPU 112-j to which the interrupt signal A is transmitted (step S1304), and returns to step S1205 of FIG. 12.

In the flowchart of FIG. 14, the sequence assuring apparatus 120 determines whether to switch a thread of a non-subject task (step S1401). For example, the sequence assuring apparatus 120 refers to a non-subject task switching flag included in the profile information and determines whether to switch the thread of the non-subject task. The sequence assuring apparatus 120 determines to switch the thread of the non-subject task if the non-subject task switching flag is “ON”, and determines to not switch the thread of the non-subject task if the non-subject task switching flag is “OFF”.

If the thread of the non-subject task is not to be switched (step S1401: NO), the sequence assuring apparatus 120 returns to step S1206 of FIG. 12. When switching the thread of the non-subject task (step S1401: YES), the sequence assuring apparatus 120 determines whether the processing time allocated to the non-subject task has elapsed (step S1402).

If the processing time for the non-subject task has not elapsed (step S1402: NO), the sequence assuring apparatus 120 returns to step S1206 of FIG. 12.

If the processing time has elapsed (step S1402: YES), the sequence assuring apparatus 120 transmits an interrupt signal I requesting the suspension of execution of the pre-switching thread of the non-subject task, to the CPU 112-i that is executing the thread of the non-subject task (step S1403).

The sequence assuring apparatus 120 then determines whether to change the operating environment of the CPU 112-i to which the interrupt signal I is transmitted (step S1404). For example, the sequence assuring apparatus 120 refers to an operating environment shafting flag included in the profile information and determines whether to change the operating environment. The sequence assuring apparatus 120 determines to change the operating environment if the operating environment shafting flag is “ON”, and determines to not change the operating environment if the operating environment shafting flag is “OFF”.

If the operating environment is not to be changed (step S1404: NO), the sequence assuring apparatus 120 proceeds to step S1406. If the operating environment is to be changed (step S1404: YES), the sequence assuring apparatus 120 transmits to the clock supply circuit 207 and the PMU 206, a control signal F for changing the operating environment (operating frequency, source voltage) of the CPU 112-i to which the interrupt signal I is transmitted, to the preset operating environment (step S1405).

The sequence assuring apparatus 120 then transmits an interrupt signal j requesting the start of execution a post-switching thread of the non-subject task to the CPU 112-i to which the interrupt signal I is transmitted (step S1406), and returns to step S1206 of FIG. 12.

Through this procedure, in the multi-core system 110, when the subject task is executed, the same operating environment as that of the single core system 130 can be reproduced and the execution sequence and processing times of threads of the subject task is also be reproduced.

In the multi-core system 110, even if switching of a thread of a non-subject task to execute is not performed by the scheduler 213-i, thread switching between non-subject tasks may be performed through transmission of the interrupt signal I and interrupt signal j. In the multi-core system 110, the operating environment of the CPU 112-i that executes a non-subject task is changed to a preferable operating environment. This improves processing capacity and achieves power saving.

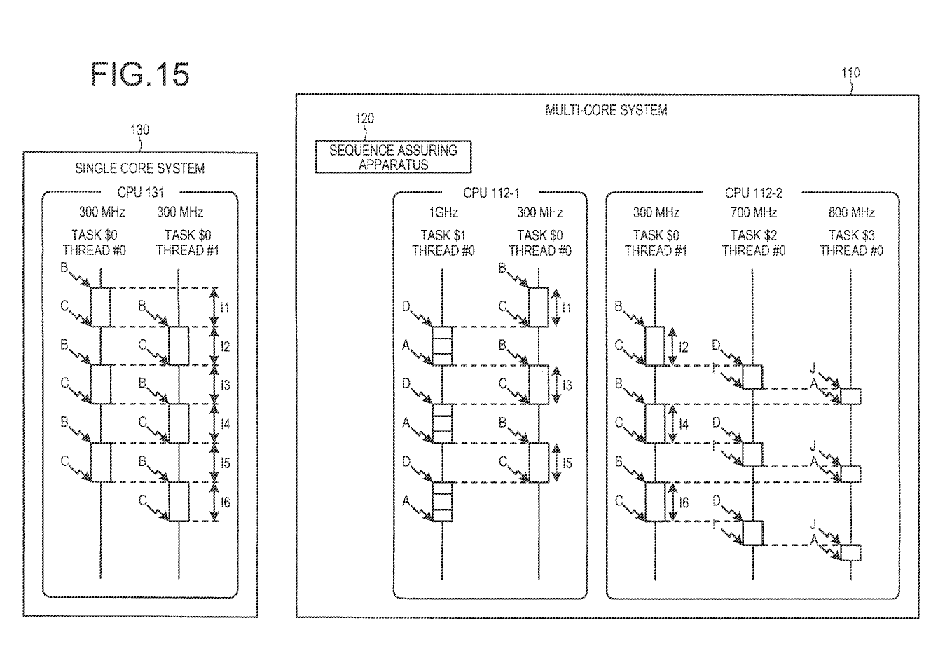

An example of execution control by the multi-core system according to the second example will be described, referring to FIG. 15.

FIG. 15 is an explanatory diagram of an example of execution control by the multi-core system according to the second example. In FIG. 15, the multi-core system 110 includes the CPUs 112-1 and 112-2. The thread #0 of the subject task $0 and the thread #0 of the non-subject task $1 are assigned to the CPU 112-1. The thread #1 of the subject task $0, the thread #0 of the non-subject task $2, and the thread #0 of the non-subject task $3 are assigned to the CPU 112-2.

When the CPU 112-1 receives a request for starting the subject task $0, the CPU 112-1 transmits to the sequence assuring apparatus 120, a sequence assurance request concerning the subject task $0 and changes the dispatch method to the interrupt permitting mode. This sequence assurance request includes task IDs for all tasks that are scheduled at the point of time of reception of the request for starting the subject task $0 and the identifier for the CPU 112-i to which the tasks are assigned.

Receiving the sequence assurance request concerning the subject task $0, the sequence assuring apparatus 120 sets the operating frequency of the CPU 112-1 to an operating frequency equal to that of the CPU 131 of the single core system 130 when the CPU 112-1 starts executing the thread #0 of the subject task $0. The sequence assuring apparatus 120 also sets the operating frequency of the CPU 112-2 to an operating frequency equal to that of the CPU 131 of the single core system 130 when the CPU 112-2 starts executing the thread #1 of the subject task $0. As a result, the operating environment of each of the CPUs 112-1 and 112-2 that are executing the subject task $0 becomes identical with the operating environment of the CPU 131 of the single core system 130.

The sequence assuring apparatus 120 calculates the execution sequence of the threads #0 and #1 of the subject task $0 and processing times for the threads #0 and #1, based on profile information of the subject task $0. Based on the time measured by the timer 121, the sequence assuring apparatus 120 transmits the interrupt signal B and interrupt signal C to the CPUs 112-1 and 112-2 according to the execution sequence and processing times of the threads #0 and #1. As a result, each of the threads #0 and #1 of the subject task $0 is executed for the same processing time as allocated in the single core system 130 (which is indicated by I1 to I6 in FIG. 15) and in the same execution sequence as set in the single core system 130.

In this manner, in the multi-core system 110, when the subject task $0 is executed, the same operating environment as that of the single core system 130 is reproduced and the execution sequence and processing times of the threads #0 and #1 of the subject task $0 are also reproduced. The multi-core system 110, therefore, causes the subject task $0 to perform the same normal operation as the subject task $0 performs in the single core system 130.

The sequence assuring apparatus 120 transmits the interrupt signals D and interrupt signal A to the CPUs 112-1 and 112-2 at which execution of the threads #0 and #1 of the subjects task $0 is suspended. This causes the CPUs 112-1 and 112-2 to start executing the non-subject tasks $1, $2, and $3.

When the CPU 112-2 having suspended execution of the thread #1 of the subject task $0 starts executing the thread #0 of the non-subject task $2, the sequence assuring apparatus 120 sets the operating frequency of the CPU 112-2 to a preferable operating frequency identified from profile information of the non-subject task $2.

When detecting the elapse of the given processing time based on the time measured by the timer 121, the sequence assuring apparatus 120 transmits the interrupt signal I to the CPU 112-2 and also transmits the interrupt signal j requesting the start of execution of the thread #0 of the non-subject task $3.

In this manner, thread switching between non-subject tasks can be performed through transmission of the interrupt signal I and interrupt signal j from the sequence assuring apparatus 120. The sequence assuring apparatus 120 can sets the operating frequency and source voltage of each of the CPUs 112-1 and 112-2 that are executing a non-subject task to an operating frequency and a source voltage that are preferable. This improves the processing capacities of the CPUs 112-1 and 112-2 and achieves power saving.

For example, when a non-subject task with high priority is executed, the operating frequencies of the CPUs 112-1 and 112-2 are raised to improve the respective processing capacities. When a non-subject task with low priority is executed, the operating frequencies of the CPUs 112-1 and 112-2 are lowered to achieve lower power consumption.

As described, according to the multi-core system 110 of the embodiment, a thread of the subject task can be executed in the same execution sequence and for the same processing time as the execution sequence and processing time of the thread in the single core system 130 through the interrupt signal B and interrupt signal C from the sequence assuring apparatus 120.

According to the multi-core system 110, through the control signal F from the sequence assuring apparatus 120, the operating environment of the CPU 112-i that executes the subject task may be changed to an operating environment identical to that of the CPU 131 of the single core system 130.

According to the multi-core system 110, through the control signal F from the sequence assuring apparatus 120, the operating environment of the CPU 112-i that executes a non-subject task may be changed to improve the processing efficiency of the CPU 112-i and achieve lower power consumption.

The above description indicates that, according to the multi-core system 110, the disparity of execution sequence of threads of the subject task is prevented. As a result, the subject task is caused to operate properly in the same manner as on the single core system 130. In this case, rewriting the program code of the subject task is unnecessary. This reduces workload on a worker and achieves a quality improvement.

The task scheduling method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

According to one aspect, an effect of preventing disparity in the execution sequence of tasks is achieved.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A task scheduling method executed by a multi-core system, the task scheduling comprising:
reading from a profile memory, first information concerning operation of a first task in a single core system;
calculating second information concerning operation of a second task in the multi-core system, based on the first information; and
setting based on the second information, an operating environment of a core that executes the second task.

2. The task scheduling method according to claim 1, wherein
the first information includes an operating frequency of a core, a bus or a memory, or a time slice, or latency information of a core, a bus or a memory.

3. The task scheduling method according to claim 1, wherein
the calculating includes calculating the second information based also on operating performance of the multi-core system.

4. The task scheduling method according to claim 1, wherein
the second information includes any one among an operating frequency and a source voltage of the core.

5. The task scheduling method according to claim 1, wherein
the setting includes setting an interrupt permitting mode that permits interrupts when the first task is executed.

6. The task scheduling method according to claim 5, comprising
suspending any one among the first task and the second task, based on setting of the interrupt permitting mode.

7. The task scheduling method according to claim 1, wherein
the setting include setting based on the first information, the operating environment of a core that executes the first task.

8. The task scheduling method according to claim 1, comprising
changing the operating environment of a core that executes the first task, from a first state to a second state; and
changing the operating environment of the first task, from the second state to the first state after the second information is calculated.

9. A task scheduling method executed by a multi-core system, the task scheduling method comprising
setting based on second information, an operating environment of a core that executes a third task.

10. A multi-core system comprising:
a plurality of CPUs that include a first CPU and a second CPU; and
a profile memory that stores first information concerning operation of a task in a single core system, wherein
the second CPU to which a second task is assigned, executes the second task in an operating environment that is based on second information concerning operation of the second task and calculated based on first information of a first task assigned to the first CPU, the first information being stored in the profile memory.

11. The multi-core system according to claim 10, wherein
the first information includes an operating frequency of a core, a bus or a memory, or a time slice, or latency information of a core, a bus or a memory.

12. The multi-core system according to claim 10, wherein
the operating environment includes any one among an operating frequency and a source voltage of a core.

13. The multi-core system according to claim 10, wherein
the multi-core system is subjected to an interrupt process in an interrupt permitting mode that permits interrupt and is set when the first task is executed, and includes an interrupt control circuit disposed for each of the CPUs.
